(19) United States
(12) Patent Application Publication
(10) Pub. No.: US 2026/0276522 A1
(43) Pub. Date: Sep. 17, 2026

(54) ANALYSIS SYSTEM AND ANALYSIS METHOD

(71) Applicant: Sony Group Corporation, Tokyo (JP)

(72) Inventor: Akio Furukawa, Tokyo (JP)

(73) Assignee: Sony Group Corporation, Tokyo (JP)

(21) Appl. No.: 19/162,567

(22) PCT Filed: Feb. 19, 2024
(86) PCT No.: PCT/JP2024/005657

§ 371 Date: Sep. 5, 2025

(30) Foreign Application Priority Data
Mar. 16, 2023 (JP) 2023-042370

(51) Int. Cl. G01N 15/1434; G02B 21/04; H04N 25/47; H04N 25/768

(52) U.S. Cl. CPC G01N 15/1434; G02B 21/04; H04N 25/47; H04N 25/768

(57) ABSTRACT

An analysis system includes an optical system that guides light from a particle flowing in a flow channel to an image sensor, in which the optical system includes an objective lens facing the flow channel, an additional objective lens that forms an image of light passing through the objective lens, and a mirror that reflects light from the additional objective lens toward the additional objective lens, light from the particle passing through a different position in the flow channel passes through the objective lens and the additional objective lens, and then is focused at a different image forming position, and the mirror has a plurality of reflective surfaces respectively positioned at different image forming positions.

### FIELD

The present disclosure relates to an analysis system and an analysis method.

### BACKGROUND

Flow cytometry is known as an analysis method of proteins of biologically relevant microparticles such as cells, microorganisms, and liposomes. A device used for flow cytometry is referred to as a flow cytometer (FCM). By irradiating fine particles flowing through a flow channel with laser light of a specific wavelength, each particle emits light such as fluorescence, forward scattered light, and side scattered light. This light is converted into an electrical signal by a photodetector and quantified, and a statistical analysis is performed to determine the type, size, structure, and the like of each particle. Note that the analysis, the determination, the evaluation, and the like may be interpreted interchangeably as long as there is no contradiction.

In recent years, a so-called imaging flow cytometer (IFCM) that acquires a two-dimensional image of fluorescence emitted from particles with an image sensor has been developed.

### CITATION LIST

### Patent Literature

Patent Literature 1: US Patent Application Publication No. 2004/0217256

### Non Patent Literature

Non Patent Literature 1: E. J. Botcherby, R. Juskaitis, M. J. Booth, T. Wilson “An optical technique for remote focusing in microscopy”, Optics Communications 281 (2008) 880-887.

### SUMMARY

### Technical Problem

Since a passage position of the particle in the flow channel is random, the passage position of the particle may deviate from a focal position of an objective lens. Since the light from the particles forms an image after passing through the objective lens, an image forming position thereof varies depending on the passage position of the particles in the flow channel. When an image is captured in a state where the image forming position deviates from the position of the image sensor, the image becomes unclear and the like, and the image quality deteriorates.

One aspect of the present disclosure suppresses deterioration in image quality.

### Solution to Problem

An analysis system according to one aspect of the present disclosure includes: an optical system that guides light from a particle flowing in a flow channel to an image sensor, wherein the optical system includes an objective lens facing the flow channel, an additional objective lens that forms an image of light passing through the objective lens, and a mirror that reflects light from the additional objective lens toward the additional objective lens, light from the particle passing through a different position in the flow channel passes through the objective lens and the additional objective lens, and then is focused at a different image forming position, and the mirror has a plurality of reflective surfaces respectively positioned at different image forming positions.

An analysis method according to one aspect of the present disclosure includes: guiding light from a particle flowing in a flow channel to an image sensor by using an optical system, wherein the optical system includes an objective lens facing the flow channel, an additional objective lens that forms an image of light passing through the objective lens, and a mirror that reflects light from the additional objective lens toward the additional objective lens, light from the particle passing through a different position in the flow channel passes through the objective lens and the additional objective lens, and then is focused at a different image forming position, and the mirror has a plurality of reflective surfaces respectively positioned at different image forming positions.

### BRIEF DESCRIPTION OF DRAWINGS

FIG. 1 is a diagram illustrating an example of a schematic configuration of an analysis system according to an embodiment.

FIG. 2 is a diagram illustrating an example of a problem.

FIG. 3 is a diagram illustrating an example of schematic configurations of an optical system and an image sensor.

FIG. 4 is a diagram illustrating an example of schematic configurations of an optical system and an image sensor.

FIG. 5 is a diagram illustrating an example of schematic configurations of an optical system and an image sensor.

FIG. 6 is a diagram illustrating an example of schematic configurations of an optical system and an image sensor.

FIG. 7 is a diagram illustrating an example of schematic configurations of an optical system and an image sensor.

FIG. 8 is a diagram illustrating an example of imaging by an image sensor.

FIG. 9 is a diagram illustrating a first modification example.

FIG. 10 is a diagram illustrating a first modification example.

FIG. 11 is a diagram illustrating a first modification example.

FIG. 12 is a diagram illustrating a second modification example.

FIG. 13 is a diagram illustrating a second modification example.

FIG. 14 is a diagram illustrating a second modification example.

FIG. 15 is a diagram illustrating an example of design of an optical system.

FIG. 16 is a diagram illustrating an example of a hardware configuration.

### DESCRIPTION OF EMBODIMENTS

Hereinafter, embodiments of the present disclosure will be described in detail with reference to the drawings. Note that, in the following embodiments, the same elements are denoted by the same reference numerals, and redundant description may be omitted.

The present disclosure will be described according to the following item order.
1. Embodiments
2. Modification Examples
3. Specific Examples of Design
4. Examples of Hardware Configuration
5. Example of Effects

### 1. Embodiments

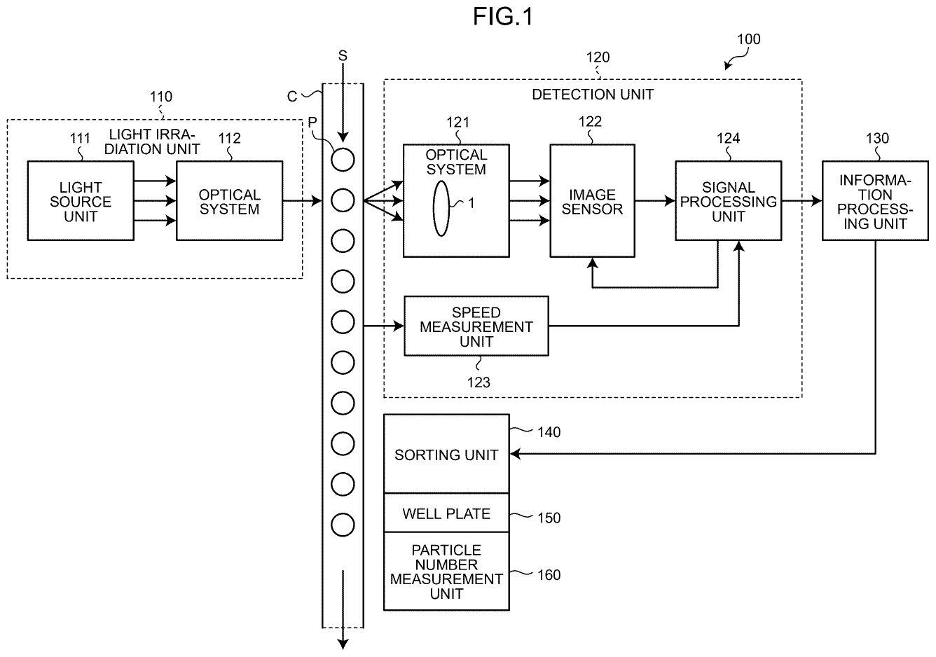

FIG. 1 is a diagram illustrating an example of a schematic configuration of an analysis system according to an embodiment. As an analysis target of an analysis system 100, a sample S flowing through a flow channel C is exemplified. The sample S includes fine particles P. An example of the sample S is a biological sample, and the particle P in that case is a biological particle. The analysis system 100 that analyzes the sample S containing such particles P can also be referred to as a biological sample analysis system, a biological particle analysis system, or the like. The system may include one or a plurality of devices, and the system and the device may be interpreted interchangeably. Unless otherwise specified, the sample S is a biological sample, and the particle P is a biological particle.

The sample S may be a liquid sample containing the particles P. Examples of the particles P are cells, non-cellular biological particles, and the like. The cell may be a live cell, and more specifically, may be a blood cell such as a red blood cell or a white blood cell, or a germ cell such as a sperm or a fertilized egg. The cells may be directly collected from a specimen such as whole blood, or may be cultured cells obtained after culture. Examples of non-cellular biological particles are extracellular vesicles, more specifically exosomes, microvesicles, and the like. Another example of the particles P is a microorganism such as yeast or bacteria. The particle P may be labeled with one or plurality of labeling substances. Examples of the labeling substances include a dye (particularly, a fluorescent dye) and a fluorescent dye labeled antibody. Note that particles other than the biological particles may be analyzed by the analysis system 100, or beads or the like may be analyzed for calibration or the like.

The flow channel C is configured such that the sample S flows, more specifically, for example, the particles P contained in the sample S flow in a substantially line. The flow channel structure including the flow channel C is designed such that a laminar flow is formed, more specifically, a laminar flow in which the flow of the sample S is enclosed by the flow of sheath fluid is formed. The flow channel C may be formed in a flow channel structure such as a microchip or a flow cell having a flow channel on the order of μm. The width of the flow channel C is 1 mm or less, and more specifically, may be 10 μm or more and 1 mm or less. Examples of the material of the flow channel structure include plastic and glass.

The flow channel C, more specifically, the particles P flowing in the flow channel C are irradiated with light from a light irradiation unit 110 described later. The interrogation point may be positioned in the flow channel structure including the flow channel C. For example, the flow channel C in the microchip or the flow cell is irradiated with light. The interrogation point may be positioned outside the flow channel structure, and in this case, the particles P after exiting from, for example, a nozzle portion of the flow channel structure may be irradiated with light (for example, a flow cytometer of a jet in air system).

The analysis system 100 includes a light irradiation unit 110, a detection unit 120, an information processing unit 130, a sorting unit 140, a well plate 150, and a particle number measurement unit 160. For example, the analysis system 100 includes the light irradiation unit 110, the detection unit 120, and the information processing unit 130, thereby having a function as a flow cytometer or an imaging flow cytometer. The analysis system 100 includes the sorting unit 140, thereby having a function as a cell sorter.

The light irradiation unit 110 irradiates the sample S flowing in the flow channel C with light. The light irradiation unit 110 includes a light source unit 111 and an optical system 112.

The light source unit 111 outputs light. The light source unit 111 includes one or a plurality of light sources. Examples of the light source include a laser light source and a light emitting diode (LED). Examples of the light include ultraviolet light, visible light, and infrared light. The light may be excitation light for exciting the particle P.

The optical system 112 condenses the light from the light source unit 111 into the flow channel C. The particle P flowing in the flow channel C is irradiated with the condensed light. The optical system 112 may include various known optical elements or optical components. Examples of the optical element or the optical component are a beam splitter, a mirror, an optical fiber, a lens, and the like. The number of interrogation points may be plural, and light from a plurality of light sources may be condensed to one irradiation point. The optical system 112 may include a lens group for condensing light, and may include, for example, an objective lens. The number of irradiation points of light on the sample S may be one or plural. The light irradiation unit 110 may be configured to condense light emitted from one or a plurality of different light sources with respect to one irradiation point.

The light from the light irradiation unit 110 is transmitted through the particle P or reflected by the particle P. The light may be scattered. In addition, in a case where the light from the light irradiation unit 110 is excitation light, the particle P emits light such as fluorescence in response to light irradiation. For example, such various kinds of light, that is, fluorescence, transmitted light, reflected light, scattered light (forward scattered light, backward scattered light, side scattered light), and the like are detected as the light from the particle P by the detection unit 120.

The detection unit 120 includes an optical system 121, an image sensor 122, a speed measurement unit 123, and a signal processing unit 124.

The optical system 121 guides the light from the inside of the flow channel C, more specifically, the light from the particles P flowing in the flow channel C, to the image sensor 122. For example, the optical system 121 may be configured to disperse light from the particles P and guide light in different wavelength ranges to each of a plurality of photodetectors, the number of which is greater than the number of fluorescent dyes (spectral-type flow cytometer). The plurality of photodetectors may correspond to one or a plurality of image sensors 122. The optical system 121 may be configured to separate light corresponding to the fluorescence wavelength region of the fluorescent dye from the light from the particles P and guide the separated light to the corresponding photodetector.

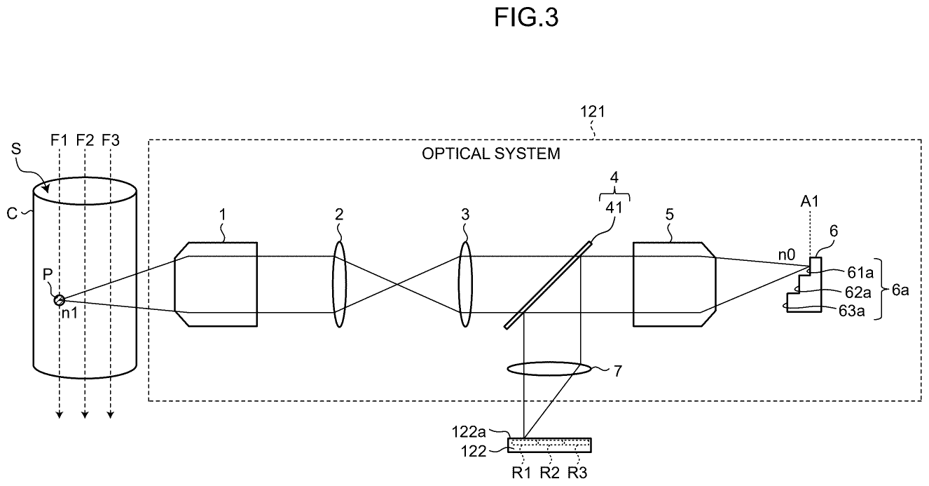

In FIG. 1, among the optical elements included in the optical system 121, an objective lens 1 is illustrated with a reference numeral. The light from the particles P passes through the optical system 121 including the objective lens 1 and is guided to the image sensor 122. Further details of the optical system 121 will be described later again with reference to FIG. 3 and subsequent drawings.

The image sensor 122 images the inside of the flow channel C, more specifically, the particles P flowing in the flow channel C. The image sensor 122 may be a charge coupled device (CCD) image sensor or a complementary metal-oxide-semiconductor (CMOS) image sensor. Some more specific examples of the image sensor 122 will be described.

For example, the image sensor 122 may be a time delay integration (TDI) type image sensor. In synchronization with the speed of the particles P, the detection value of a certain line may be transferred to the adjacent line and integrated. The image sensor 122 may include single-photon avalanche diode (SPAD) pixels that detect incidence of one photon (TDI-PAD sensor). As a technique related to this, for example, matters disclosed in Japanese Patent Application No. 2021-110227 may be appropriately referred to in the present disclosure.

The image sensor 122 may be an event-based vision sensor (EVS). The EVS includes a plurality of event pixels arranged in a two-dimensional lattice such that an event can be detected on the basis of a change in the brightness of the incident light. The EVS outputs, in a synchronous or asynchronous manner, event data including positional information (X address and Y address) of the pixel in which the event has been detected, polarity information (positive event/negative event) of the detected event, information (time stamp) of the time when the event has been detected, and the like. For example, the image sensor 122 outputs a series of event data (event stream) generated in each pixel with respect to the image of the particle P moving on the light receiving surface. The TDI processing may be performed in software by using the time stamp included in the event data. As a technique related to this, for example, matters disclosed in WO 2022/107557 may be appropriately referred to in the present disclosure.

The image sensor 122 may be a normal frame type image sensor. In that case, the image sensor 122 outputs an image (frame) at a predetermined frame rate. Note that the image can be referred to as image data, and the frame can be referred to as frame data. The image and the frame may be respectively interpreted as the image data and the frame data as long as there is no contradiction.

The above-described event stream, frame, and the like output by the image sensor 122 are also simply referred to as an image output by the image sensor 122. The image from the image sensor 122 is transmitted to the signal processing unit 124 and processed, and data obtained therefrom is further transmitted to the information processing unit 130. Various pieces of information regarding the particles P can be obtained by various types of processing. An example of the obtained information is particle information (also referred to as biological particle information) such as an image of the particle P, a feature amount of the particle P, and an attribute of the particle P. Examples of the image of the particle P include a bright-field image, a dark-field image, and a fluorescence image.

The speed measurement unit 123 measures, for example, a relative speed of the particle P flowing in the flow channel C with respect to the flow channel C. Unless otherwise specified, it is assumed that the speed measurement unit 123 is stationary with respect to the flow channel C, and the speed measurement unit 123 measures the speed of the particle P. Various known measurement methods such as an electrostatic method and an optical method may be used. A signal indicating a measurement result of the speed of the particle P is transmitted to the signal processing unit 124 as needed.

Note that, in a case where the speed of the particle P is known, the measurement by the speed measurement unit 123 may not be performed, and in this case, the detection unit 120 may not include the speed measurement unit 123. For example, it can be said that the speed of the particle P is known in a case where the speed of the particle P flowing through the flow channel C is maintained at a desired speed by controlling a pump system that delivers the sample S. However, even in such a case, the speed of the particle P can fluctuate due to ambient temperature, a change in resistance of a liquid delivery system, and the like, and thus, measurement by the speed measurement unit 123 can be effective.

In a case where the signal from the image sensor 122 is an analog electrical signal, the signal processing unit 124 converts the analog signal into a digital signal (A/D conversion). The obtained digital signal is transmitted to the information processing unit 130, and can be handled as data (optical data) regarding light. The optical data may include, for example, data regarding fluorescence and data regarding light intensity. The light intensity may be light intensity data of light including fluorescence. Such light intensity data may include feature amounts such as Area, Height, and Width.

For example, in a case where the image sensor 122 is a frame type image sensor, the signal processing unit 124 executes predetermined processing such as white balance adjustment and distortion correction on the frames from the image sensor 122, and transmits the processed frames to the information processing unit 130. In a case where the image sensor 122 is the EVS, the signal processing unit 124 reconstructs the frame including the particle P on the basis of the event stream from the image sensor 122 and the speed measurement result from the speed measurement unit 123, and transmits the reconstructed frame to the information processing unit 130. In a case where the image sensor 122 is the TDI type image sensor, the signal processing unit 124 constructs the frame from a predetermined number of lines, and transmits the constructed frame to the information processing unit 130.

Note that, for example, in a case where the image sensor 122 is the EVS, the change in the speed of the particle P is sufficiently gentle as compared with the arrival frequency of the particle P. Therefore, the speed of the particle P used for reconstructing the frame is not limited to the speed of the particle P itself included in the frame to be reconstructed, and may be the speed, the average value, or the like of the particle P arriving before and/or after the particle P included in the frame.

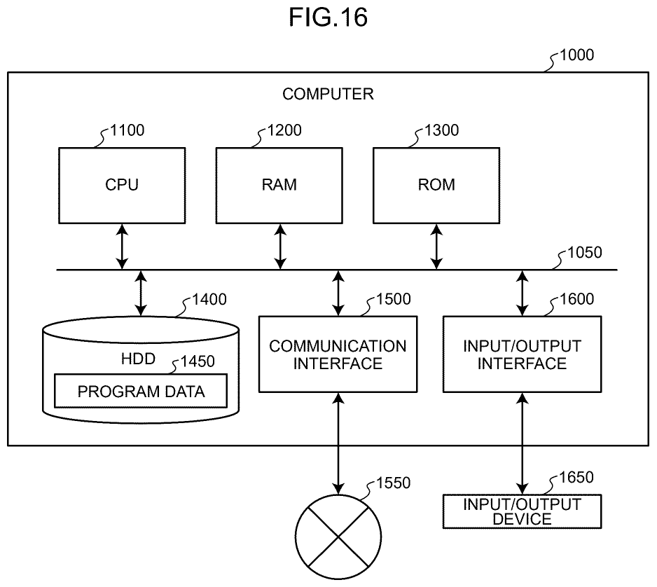

The signal processing unit 124 may be realized using a general-purpose computer, which will be described later with reference to FIG. 16. A part or all of the functions of the signal processing unit 124 may be realized by a server computer or a cloud connected via a network.

The information processing unit 130 processes various kinds of information including the above-described optical data. For example, the information processing unit 130 analyzes the data of the frame from the signal processing unit 124 of the detection unit 120, and executes correction to offset the rotation of the particle P flowing through the flow channel C, extraction of the feature amount thereof, discrimination of the type of the particle P, and the like. The information processing unit 130 may include a display and the like, and in that case, the biological particle information used for analysis, the feature amount based on a result of the analysis, the statistical data, a discrimination result of the type, and the like may be displayed. For example, optical data, an image, a two-dimensional plot or a spectral plot generated on the basis of the optical data, and the like may be displayed. The information processing unit 130 may include a keyboard or the like for receiving inputs of various kinds of data. For example, gating processing on a plot by the user may be accepted.

In a case where the data from the detection unit 120 is optical data corresponding to the fluorescent dye, the information processing unit 130 may perform fluorescence leakage correction (compensation processing) on the light intensity data. In a case where the analysis system 100 is a spectral-type flow cytometer, the information processing unit 130 may execute fluorescence separation processing on the optical data and acquire the light intensity data corresponding to the fluorescent dye. The fluorescence separation processing may be performed according to an unmixing method as disclosed in, for example, Japanese Patent Application Laid-Open No. 2011-232259. In addition, the information processing unit 130 may acquire morphological information of the particle P on the basis of the image of the particle P.

In addition, the information processing unit 130 determines whether or not the particle P is sorted on the basis of the optical data and/or the morphological information. The processing unit 131 controls the sorting unit 140 to sort the particle P on the basis of the determination result. For example, by controlling the sorting unit 140 on the basis of the type discrimination result of the particles P, the particles P of a specific type are sorted and collected.

Various kinds of information used by the information processing unit 130 are stored (saved or the like) in the information processing unit 130. For example, the acquired optical data, the spectral reference data used in the unmixing processing, and the like are stored.

The information processing unit 130 may be realized using a general-purpose computer, which will be described later with reference to FIG. 16. The information processing unit 130 may be provided in a housing in which the light irradiation unit 110 and the detection unit 120 are mounted, or may be provided outside the housing. A part or all of the functions of the information processing unit 130 may be realized by a server computer or a cloud connected via a network.

The sorting unit 140 sorts the particles P, for example, according to the determination result by the information processing unit 130. An example of the sorting method is a method of generating a droplet containing the particle P by vibration, applying a charge to the droplet as a sorting target, and controlling a traveling direction of the droplet by an electrode. Another example of the sorting method is a method of controlling the traveling direction of the particle P in the flow channel structure to perform sorting. The flow channel structure is provided with, for example, a control mechanism by pressure (injection or suction) or charge. As the flow channel structures, for example, as known in Japanese Patent Application Laid-Open No. 2020-76736, a chip may be used which has a flow channel structure in which the flow channel C branches into a collection flow channel and a waste liquid flow channel on the downstream side thereof, and specific particles P are collected into the collection channel.

The sorting unit 140 sorts the particles P moving in the flow channel C one by one into each well of the well plate 150 on the basis of the type discrimination result of the particles P by the information processing unit 130. The particles P of a specific type are sorted and collected in each well of the well plate 150.

The particle number measurement unit 160 measures the number of particles P sorted into each well by scanning each well of the well plate 150 in a depth direction while illuminating each well with the light source unit. The particle number measurement unit 160 includes, for example, the light source unit, an imaging unit, a scanning mechanism, and the like.

With the above-described configuration, the analysis system 100 analyzes the particles P flowing in the flow channel C. Describing an example of the operation, the light irradiation unit 110 irradiates the inside of the flow channel C, more specifically, the particles P flowing in the flow channel C with light. The detection unit 120 uses the optical system 121 and the image sensor 122 to capture an image of light from the inside of the flow channel C, more specifically, light from the particles P flowing in the flow channel C. An image of the particle P is obtained and observed in real time. The information processing unit 130 controls the sorting unit 140 on the basis of the data from the detection unit 120. The sorting unit 140 sorts the target particle P into each well of the well plate 150. The particle number measurement unit 160 measures the number of particles P in each well.

### <Problem 1>

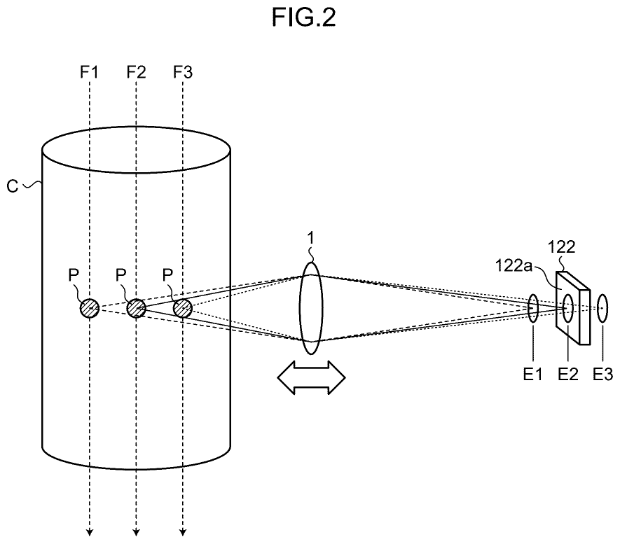

Since a passage position of the particle P in the flow channel C is random, the passage position of the particle P may deviate from the focal position of the objective lens 1. Since the light from the particles P forms an image after passing through the objective lens 1, an image forming position thereof varies depending on the passage position of the particles P in the flow channel C. When an image is captured in a state where the image forming position deviates from the position of the image sensor 122, the image becomes unclear and the like, and the image quality deteriorates. A description will be given with reference to FIG. 2.

FIG. 2 is a diagram illustrating an example of a problem. Since the passage position of the particle P in the flow channel C is random, the position of the path of the particle P in the flow channel C, more specifically, the position of the path in a width direction of the flow channel C can vary. Specifically, FIG. 2 illustrates three path F1 to the path F3 passing through different positions in the flow channel C. The path F1 is farthest from the objective lens 1, and the path F3 is closest to the objective lens 1. The path F2 is positioned between the path F1 and the path F3, and passes through the center in the flow channel C in this example.

A position where the light from the particle P on the path F1 forms an image after passing through the objective lens 1 is referred to as an image forming position E1 in the drawing. Similarly, a position where the light from the particle P on the path F2 forms an image is referred to as an image forming position E2 in the drawing. A position where the light from the particle P on the path F3 forms an image is referred to as an image forming position E3 in the drawing.

The focal position of the objective lens 1 is adjusted so as to be positioned, for example, in any of the path F1, the path F2, and the path F3. In this example, it is assumed that the focal position of objective lens 1 is adjusted to path F2. The path F2 is positioned at the focal position of the objective lens 1. The image forming position E2 of the light from the particle P on the path F2 is positioned on the image sensor 122, specifically, on the light receiving surface thereof. On the other hand, the path F1 deviates from the focal position of the objective lens 1. The image forming position E1 of the light from the particle P on the path F1 deviates from the image sensor 122. Similarly, the path F3 deviates from the focal position of the objective lens 1. The image forming position E3 of the light from the particle P on the path F3 deviates from the image sensor 122. In this case, the image of the particle P passing through the path F1 or the path F3 becomes an unfocused and unclear image.

For example, it is also conceivable to measure the passage position of the particle P in the flow channel C and move (focus adjustment) the objective lens 1 by a moving mechanism or the like in order to focus on each passage position. However, when the optical element such as the objective lens 1 is physically moved, there is a problem that the focus adjustment speed is very slow with respect to the speed of the particle P. In order to adjust the focal position to the passage position of the particle P by the time of imaging, it is conceivable that an index having a high correlation with the deviation between the focal position and the passage position of the particle P is measured in advance, and the driving of the focus mechanism is started in advance on the basis of the measurement result. However, an error occurs due to the fact that the correlation between the measurement index and the deviation of the passage position of the particle P from the actual focal position does not completely match. In addition, since it takes time to change the focal position of the optical system 121, when the number of particles P is increased and the imaging interval becomes short, there is also a problem that focus adjustment for each particle P cannot be made in time.

For example, Patent Literature 1 discloses a method for detecting the deviation of a cell from the focal position from a combination of temporal waveforms of the scattered light intensity from the cell transmitted through a pair of gratings. In addition, Patent Literature 1 proposes a method of estimating the subsequent change from the tendency of the temporal change of the detected focal deviation and moving the lens so that the focal position reaches the estimated value. However, since the estimated amount depends on the size and shape of the cell, there is a problem that it is difficult to maintain sufficient accuracy for general purposes.

### <Addressing Problem 1>

The above-described problems are addressed by the disclosed techniques. This will be described with reference to FIGS. 3 to 7.

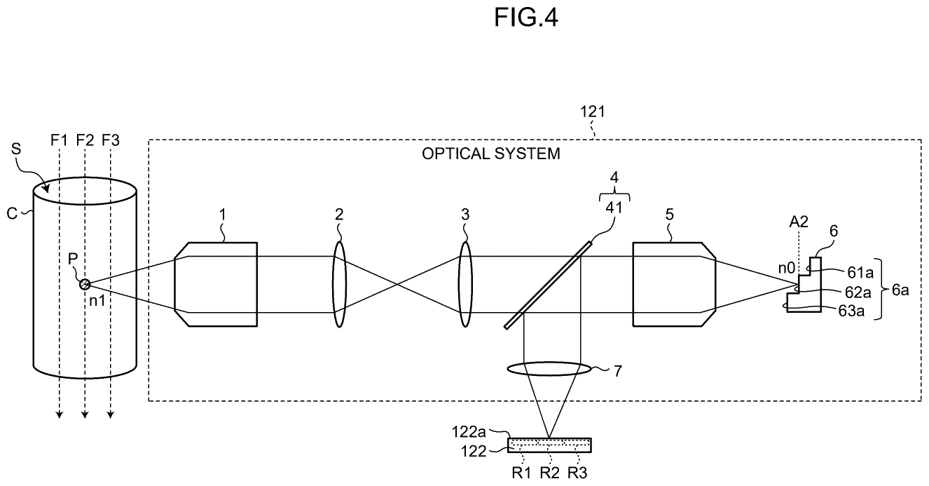

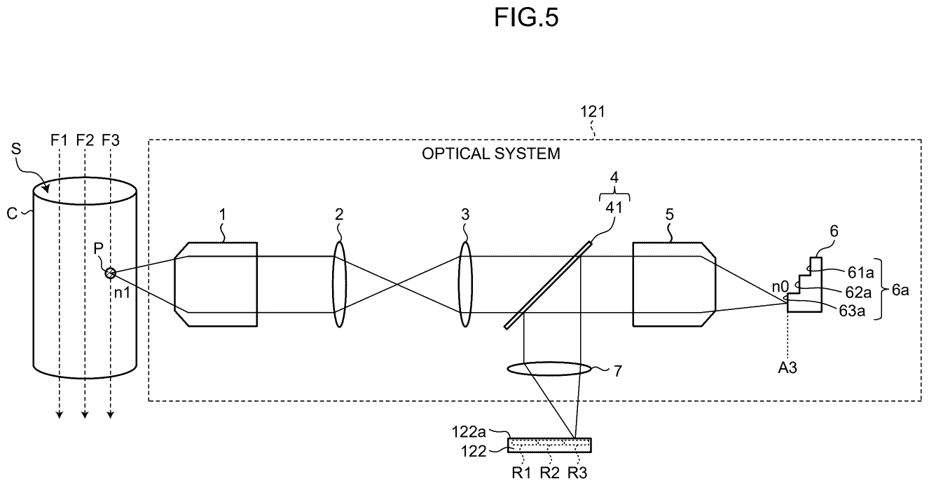

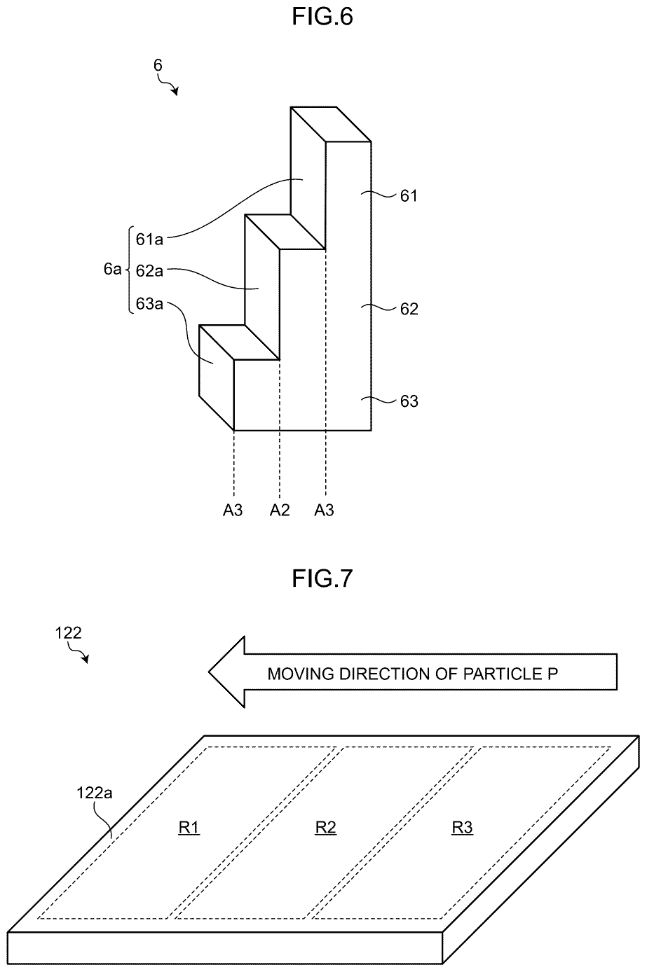

FIGS. 3 to 7 are diagrams illustrating examples of the schematic configurations of the optical system and the image sensor. In addition to the configurations of the optical system 121 and the image sensor 122, the light (a part of the light beam) from the particle P is schematically illustrated. FIG. 3 illustrates the particle P passing through the path F1. FIG. 4 illustrates the particle P passing through the path F2. FIG. 5 illustrates the particle P passing through the path F3. FIG. 6 schematically illustrates a mirror 6 (described later) when viewed obliquely. FIG. 7 schematically illustrates the image sensor 122 when viewed obliquely.

In addition to the objective lens 1 described above, the optical system 121 includes a relay lens 2, a relay lens 3, an intermediate optical element 4, an additional objective lens 5, the mirror 6, and an imaging lens 7.

The objective lens 1 is disposed to face the flow channel C. The objective lens 1 may have a focal position in the flow channel C. Unless otherwise specified, the focal position of the objective lens 1 is adjusted to be positioned on the path F2 in the flow channel C. The objective lens 1 may be provided with spherical aberration correction with respect to the focal plane.

The relay lens 2 and the relay lens 3 are arranged in this order between the objective lens 1 and the additional objective lens 5, more specifically, between the objective lens 1 and the intermediate optical element 4 in this example. The relay lens 2 and the relay lens 3 relay light from the objective lens 1 to the intermediate optical element 4. Note that, unless otherwise specified, light that is from the objective lens 1 and has passed through the relay lens 2 and the relay lens 3 is also referred to as light from the objective lens 1.

The intermediate optical element 4 is disposed between the objective lens 1 and the additional objective lens 5, more particularly between the relay lens 3 and the additional objective lens 5 in this example. The intermediate optical element 4 guides at least a part of the light from the objective lens 1 to the additional objective lens 5. In the examples illustrated in FIGS. 3 to 5, the intermediate optical element 4 includes a half mirror 41. The half mirror 41 allows a part of the light from the objective lens 1 to pass toward the additional objective lens 5. Note that the passage may be understood as meaning of transmission, and the passage and the transmission may be used interchangeably as long as there is no contradiction.

The additional objective lens 5 forms an image of light from the intermediate optical element 4, that is, light that is from the particle P and has passed through the objective lens 1. Similarly to the objective lens 1, the additional objective lens 5 may be provided with spherical aberration correction with respect to the focal plane. Furthermore, the additional objective lens 5 may have the same size, magnification, and focal length as the size, magnification, and focal length of the objective lens 1. The additional objective lens 5 may be exactly the same objective lens as the objective lens 1, for example, an objective lens of the same model number.

The mirror 6 is disposed to reflect the light from the additional objective lens 5 toward the additional objective lens 5. A reflective surface of the mirror 6 is referred to as a reflective surface 6a in the drawing. The mirror 6 is disposed such that the reflective surface 6a faces the additional objective lens 5. The light from the additional objective lens 5 forms an image on the reflective surface 6a of the mirror 6.

Here, there is a problem that light from different positions in the flow channel C passes through the objective lens 1 and the additional objective lens 5 and then forms an image at different image forming positions. That is, the image forming position of the light by the additional objective lens 5 varies depending on which path the light from the particle P takes in the flow channel C.

Specifically, the image forming position of the light from the particle P on the path F1 is referred to as an image forming position A1 in the drawing (FIG. 3). The image forming position of the light from the particle P on the path F2 is referred to as an image forming position A2 in the drawing (FIG. 4). The image forming position of the light from the particle P on the path F3 is referred to as an image forming position A3 in the drawing (FIG. 5). As can be understood, the image forming position A1, the image forming position A2, and the image forming position A3 are all positioned at different positions.

In the present embodiment, (the reflective surface 6a of) the mirror 6 has a plurality of reflective surfaces positioned at different image forming positions. Examples of the plurality of reflective surfaces include a reflective surface 61a, a reflective surface 62a, and a reflective surface 63a. More specifically, as illustrated in FIG. 6, the mirror 6 includes a first portion 61, a second portion 62, and a third portion 63, and has a staircase shape of which the thickness is changed in three stages. The first portion 61 has the reflective surface 61a. The second portion 62 has the reflective surface 62a. The third portion 63 has the reflective surface 63a. The reflective surface 61a of the mirror 6 is positioned at the image forming position A1. The reflective surface 62a of the mirror 6 is positioned at the image forming position A2. The reflective surface 63a of the mirror 6 is positioned at the image forming position A3.

Of the light from the additional objective lens 5, the light from the particle P on the path F1 forms an image on the reflective surface 61a of the mirror 6 and is reflected toward the additional objective lens 5. The light from the particle P on the path F2 forms an image on the reflective surface 62a of the mirror 6 and is reflected toward the additional objective lens 5. The light from the particle P on the path F3 forms an image on the reflective surface 63a of the mirror 6 and is reflected toward the additional objective lens 5. After being reflected by the mirror 6, all the light passes through the additional objective lens 5 and reaches the intermediate optical element 4.

The intermediate optical element 4 guides at least a part of light, which has been reflected by the mirror 6 and has passed through the additional objective lens 5, to the image sensor 122. In this example, the half mirror 41 reflects a part of the light from the additional objective lens 5 toward the mirror 6.

The imaging lens 7 is disposed between the intermediate optical element 4 and the image sensor 122. The imaging lens 7 forms an image of light from the intermediate optical element 4, more specifically, light that has been reflected by the mirror 6 and has passed through the additional objective lens 5, on the image sensor 122.

The image sensor 122 images light from the imaging lens 7, that is, the particle P. The light receiving surface of the image sensor 122 is referred to as a light receiving surface 122a in the drawing. The image sensor 122 is disposed such that the light receiving surface 122a is positioned at the image forming position of the light from the imaging lens 7.

A region where the light is focused most and imaged in the image sensor 122 differs depending on which position in the flow channel C the light is from, that is, which path the light from the particle P takes in the flow channel C. In the image sensor 122, a region where the light, which is from the particle P on the path F1 and has been reflected by the reflective surface 61a of the mirror 6, is focused most and imaged is referred to as a region R1 in the drawing. A region where the light, which is from the particle P on the path F2 and has been reflected by the reflective surface 62a of the mirror 6, is focused most and imaged is referred to as a region R2 in the drawing. A region where the light, which is from the particle P on the path F3 and has been reflected by the reflective surface 63a of the mirror 6, is focused most and imaged is referred to as a region R3 in the drawing.

As illustrated in FIG. 7, the region R3, the region R2, and the region R1 of the image sensor 122 are positioned in this order corresponding to the moving direction of the particle P. The image sensor 122 sequentially generates images of the images formed in order of the region R3, the region R2, and the region R1, and transmits the images to the signal processing unit 124 (FIG. 1).

As described above with reference to FIG. 1 again, the signal processing unit 124 transmits the frame based on the image from the image sensor 122 to the information processing unit 130. The information processing unit 130 evaluates a focus state of each image with respect to the particle P from the sequentially transmitted frames.

The passage position of the particle P in the flow channel C and the clarity of the image of the particle P in the image will be described. For example, in a case where the particle P passes through the path F2, a clear image of the particle P is obtained in the region R2 of the image sensor 122. The images obtained in the other region R1 and region R3 are less clear than that.

The information processing unit 130 analyzes the images sequentially transmitted from the image sensor 122 via the signal processing unit 124, thereby evaluating the focus state for the particle P included in each image. Various known methods such as a contrast detection method and a phase difference detection method may be used. For example, the following evaluation values are calculated, and the image having the highest result obtained by combining any one or two or more of the evaluation values is evaluated as the image having the best focus state.
1. Integrated Value of Brightness Difference between Adjacent Pixels in Entire or Partial Region of Image (for Example, Region Corresponding to Particle P)
2. Intensity Value of High-Frequency Component in Entire or Partial Region of Image (for Example, Region Corresponding to Particle P)
3. Outer Diameter Dimension of Image of Particle P in Image

Note that the optical path length until the light from the particle P reaches the image sensor 122 varies depending on the position of the particle P, and the size of the image may vary. In that case, for each image, the focus state may be evaluated for a portion corresponding to the same region of the same particle P. In one embodiment, an evaluation target region in each image may be specified on the basis of a relationship between the speed when the particle P passes through the field of view of the objective lens 1 and the acquisition time of each image.

For example, as described above, a series of images including the image focused on the particle P can be acquired even in a case where the particle P passes through any of the path F1 to the path F3. By selecting an image with a good focus from the series of images, the image focused on the particle P by the objective lens 1 can be obtained. It is possible to suppress deterioration in image quality due to deviation of the passage position of the particle P from the focal position of the objective lens 1.

Note that the particle P may be present over two or more paths of the path F1 to the path F3. In this case, an image including the particle P can be obtained by synthesizing or multilayering a plurality of corresponding images.

In addition, since it is not necessary to execute focus adjustment on each particle P, even in a case where the number of particles P is increased and the imaging interval becomes short, it is possible to suppress deterioration in image quality due to deviation of the passage position of the particle P from the focal position of the objective lens 1. In addition, since the focus adjustment based on the index having a high correlation with the deviation between the focal position and the passage position of the particle P is unnecessary, it is also possible to suppress the occurrence of an error due to a matching degree of the correlation.

The image having a good focus state selected as described above may be used for processing such as analysis and identification of the particle P in the information processing unit 130.

Note that in the above description, as the plurality of reflective surfaces of the mirror 6, the three reflective surfaces of the reflective surface 61a, the reflective surface 62a, and the reflective surface 63a have been described as an example. However, the number of reflective surfaces of the mirror 6 may be two or four or more. The mirror 6 may have a staircase shape of the number of steps corresponding to the number of reflective surfaces.

### <Problem 2>

Further problems will be described. Since the focal position of the objective lens 1 is adjusted to a specific position in the flow channel C and spherical aberration correction is performed on the focal plane, spherical aberration may occur for light from the particle P passing through other positions in the flow channel C. Due to the spherical aberration, blurring occurs in the periphery of the particle P in the image or the resolution deteriorates, so that the image quality deteriorates. In particular, the problem becomes apparent in a case where the NA of the objective lens 1 is high. This problem is addressed as described next.

### <Addressing Problem 2>

With reference to FIGS. 3 to 5 again, addressing the spherical aberration will be described. As described above, the optical system 121 includes not only the objective lens 1 but also the additional objective lens 5. By including the additional objective lens 5, the spherical aberration of the light from the particle P that has passed through the objective lens 1 is canceled (corrected).

More specifically, the refractive index in the flow channel C is referred to as a refractive index n1 in the drawing. The refractive index of the peripheral region of the mirror 6 is referred to as a refractive index no in the drawing. The optical system 121 is designed such that an image forming magnification of light from the particle P on the mirror 6 matches a ratio (n1/n0) of the refractive index n1 to the refractive index no. As a result, the spherical aberration of the light that has passed through the objective lens 1 is canceled by the light passing through the additional objective lens 5. Since a specific principle is known in, for example, Non Patent Literature 1, the description thereof is omitted here.

The light that has passed through the additional objective lens 5 forms an image on the light receiving surface 122a of the image sensor 122 in a state where there is no spherical aberration (or reduced). Therefore, even in a case where the particle P passes through any of the path F1, the path F2, and the path F3, a clear image can be obtained.

Note that the image forming magnification from the particle P on the mirror 6 is limited by the values of the refractive index no and the refractive index n1, but the image forming magnification on the image sensor 122 can be designed by adjusting the image forming magnification of the imaging lens 7. For example, the image forming magnification of the imaging lens 7 may be designed to obtain a desired resolution in consideration of the pixel size of the image sensor 122 and the like. In one embodiment, the imaging lens 7 may have a magnification greater than the image forming magnification of the light from the particle P on the mirror 6. The possibility of obtaining a high-resolution image is increased.

For example, as described above, deterioration of the image quality due to the spherical aberration can also be suppressed.

### <Example of Imaging by Image Sensor 122>

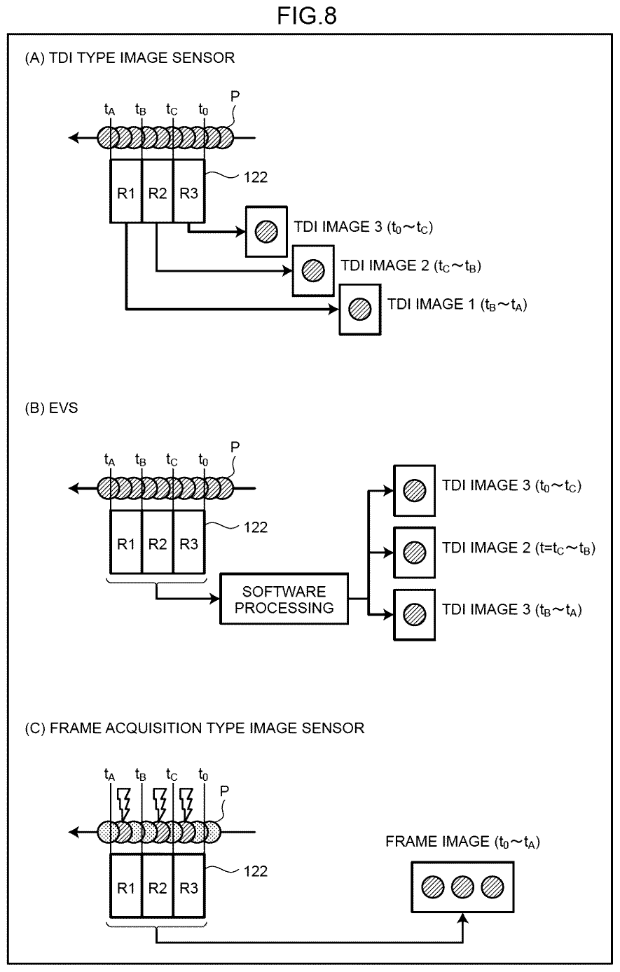

As described above, various image sensors may be used as the image sensor 122. Some specific examples of imaging by the image sensor 122 will be described with reference to FIG. 8.

FIG. 8 is a diagram illustrating an example of imaging by the image sensor. The position of the particle P is changed with time. An image of the particle P obtained in the region R3 between time t₀ and time t_{C}, an image of the particle P obtained in the region R2 between time t_{C} and time t_{B}, and an image of the particle P obtained in the region R1 between time t_{B} and time t_{A} are selected.

In the example illustrated in (A) of FIG. 8, the image sensor 122 is a TDI type image sensor. The image sensor 122 is configured to output a TDI image for each divided region, in this example, a TDI image of each of the region R3, the region R2, and the region R1. The images obtained in the region R3 between time t₀ and time t_{C} are integrated to obtain an image (TDI image 3) of the particle P in the time zone. The images obtained in the region R2 between time t_{C} and time t_{B} are integrated to obtain an image (TDI image 2) of the particle P in the time zone. The images obtained in the region R1 between time t_{B} and time t_{A} are integrated to obtain an image (TDI image 1) of the particle P in the time zone. Even in a case where the speed of the particles P flowing through the flow channel C is faster than the exposure time required to acquire a still image, a still image with sufficient brightness and no blurring can be obtained.

In the example illustrated in (B) of FIG. 8, the image sensor 122 is an EVS. The possibility of obtaining high detection sensitivity, high-speed operation, and the like is increased as compared with the case of using a normal image sensor. For example, as disclosed in WO 2022/107557, by using a pixel position and a time stamp for each event, a TDI image for each divided region can be obtained by software processing. In this example, the TDI image 3 is obtained from the data obtained in the region R3 between time t₀ and time t_{C}. The TDI image 2 is obtained from the data obtained in the region R2 between time t_{C} and time t_{B}. The TDI image 1 is obtained from the data obtained in the region R1 between time t_{B} and time t_{A}. In addition to the advantages of the TDI type image sensor described above, the TDI processing and the individual imaging processing for each region can be realized by software.

In the example illustrated in (C) of FIG. 8, the image sensor 122 is a normal frame type image sensor. In this example, pulse-type illumination is applied at the timing when the particle P passes through the position corresponding to each divided region of the image sensor 122, that is, each of the region R3, the region R2, and the region R1. For example, the light irradiation unit 110 described above with reference to FIG. 1 performs pulse illumination in the flow channel C in conjunction with the passage position of the particle P in the flow channel C. A plurality of images obtained by capturing the same particle P at different times and focal planes are acquired as frame images from time t₀ to time t_{A}. There is no need to individually perform TDI processing of images having different focal planes, and imaging can be performed in a single frame.

Note that the divided region as described above may be realized by using a plurality of image sensors 122 each corresponding to one divided region, instead of the region in the single image sensor 122.

In addition, in a case where the analysis system 100 includes a plurality of image sensors 122, different types of image sensors, for example, the above-described TDI type image sensor, EVS, and normal frame type image sensors may be arbitrarily combined and used.

### 2. Modification Examples

The disclosed technique is not limited to the above embodiments. Some modification examples will be described.

### First Modification Example

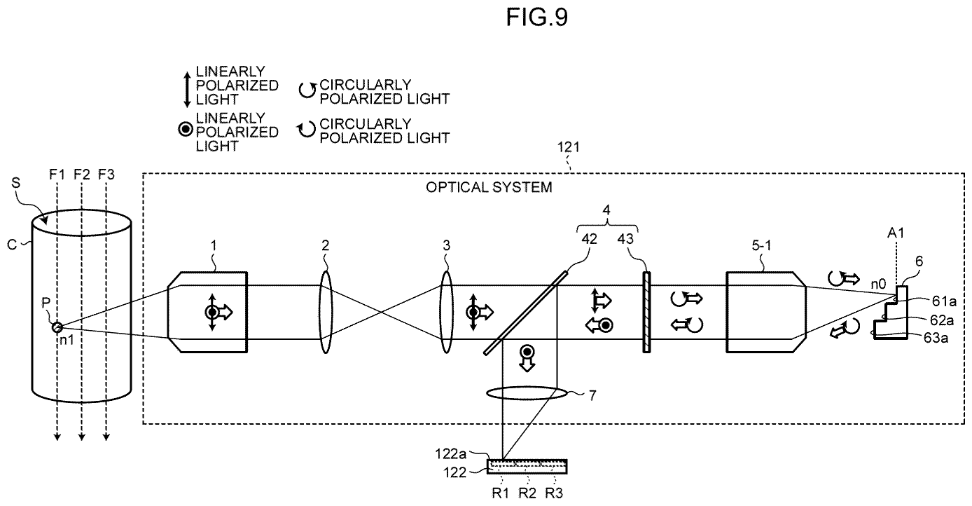

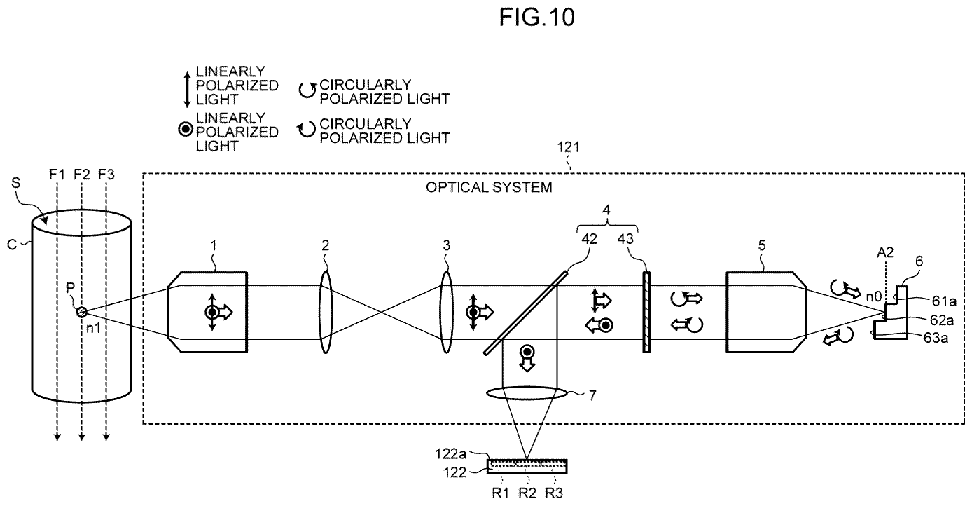

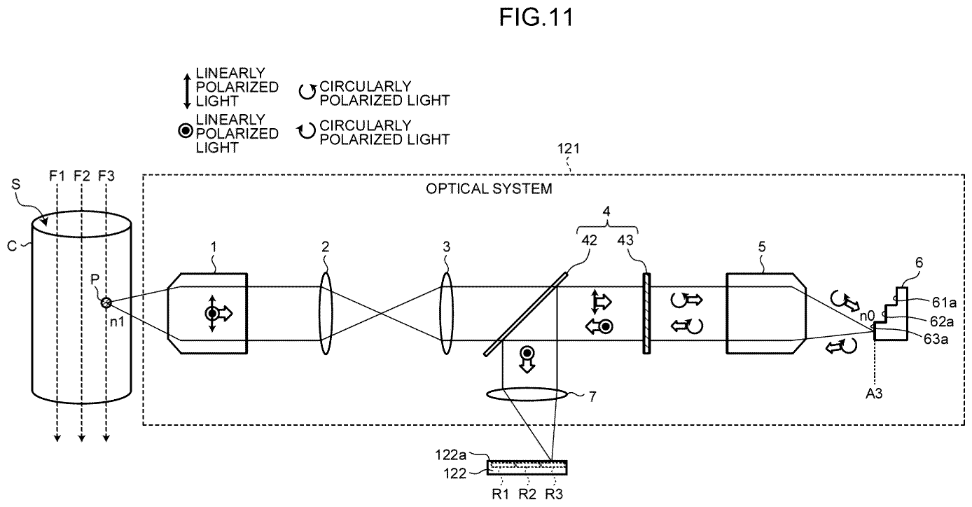

FIGS. 9 to 11 are diagrams illustrating a first modification example. FIG. 9 illustrates the particle P passing through the path F1. FIG. 10 illustrates the particle P passing through the path F2. FIG. 11 illustrates the particle P passing through the path F3.

In this example, as compared with the configuration of FIGS. 3 to 5 described above, the intermediate optical element 4 of the optical system 121 does not include the half mirror 41, but includes a polarization beam splitter 42 and a quarter-wave plate 43. The polarization beam splitter 42 is disposed closer to the objective lens 1 side (in this example, the relay lens 3 side) than the quarter-wave plate 43. The quarter-wave plate 43 is disposed closer to the additional objective lens 5 than the polarization beam splitter 42.

The traveling direction of the light in some places is schematically indicated by a white arrow, and the type of polarized light (the type of polarization component) is also schematically indicated together therewith. Examples of the polarized light include linearly polarized light and circularly polarized light.

As the linearly polarized light, two types of linearly polarized light are illustrated. Specifically, horizontally polarized light having a horizontal polarization component and vertically polarized light having a vertical polarization component are illustrated. Here, the linearly polarized light having a polarization component parallel to the paper surface is referred to as horizontally polarized light. The linearly polarized light having a polarization component perpendicular to the paper surface is referred to as vertically polarized light. In a case where the horizontally polarized light and the vertically polarized light are not particularly distinguished, they are simply referred to as linearly polarized light.

Two types of circularly polarized light are illustrated as circularly polarized light. Specifically, right-handed circularly polarized light having a right-handed circular polarization component and right-handed circularly polarized light having a left-handed circular polarization component are illustrated. In a case where they are not particularly distinguished, they are simply referred to as circularly polarized light.

The light from the particles P may be unpolarized light. In this case, it can be said that the light from the particles P includes two types of linearly polarized light of the horizontally polarized light and the vertically polarized light. This light passes through the objective lens 1, the relay lens 2, and the relay lens 3 and enters the polarization beam splitter 42.

The polarization beam splitter 42 transmits one linearly polarized light of the two types of linearly polarized light included in the light from the objective lens 1 and reflects the other linearly polarized light. Here, it is assumed that one linearly polarized light is the horizontally polarized light and the other linearly polarized light is the vertically polarized light.

The quarter-wave plate 43 converts the linearly polarized light from the polarization beam splitter 42 into corresponding circularly polarized light. In this example, the quarter-wave plate 43 converts horizontally polarized light into the right-handed circularly polarized light.

The circularly polarized light from the intermediate optical element 4, in this example, the right-handed circularly polarized light is focused on the reflective surface 6a of the mirror 6 by the additional objective lens 5 and is reflected by the reflective surface 6a. By this reflection, the polarization direction of the circularly polarized light is reversed. In this example, the right-handed circularly polarized light becomes the left-handed circularly polarized light. The left-handed circularly polarized light passes through the additional objective lens 5 and enters the quarter-wave plate 43.

The quarter-wave plate 43 converts the circularly polarized light, which has been reflected by the mirror 6 and has passed through the additional objective lens 5, into corresponding linearly polarized light. In this example, the polarization beam splitter 42 converts the left-handed circularly polarized light into the vertically polarized light.

The polarization beam splitter 42 reflects the linearly polarized light from the quarter-wave plate 43, in this example, the vertically polarized light toward the image sensor 122 (toward the imaging lens 7). This light is focused by the imaging lens 7 and is imaged by the image sensor 122.

Also in the above configuration, by the intermediate optical element 4, at least a part of the light from the objective lens 1 is guided to the additional objective lens 5, and at least a part of the light that has been reflected by the mirror 6 and has passed through the additional objective lens 5 is guided to the image sensor 122. Therefore, even in a case where the particle P passes through any of the path F1 to the path F3, an image focused on the particle P can be obtained. In addition, since the light passes through the additional objective lens 5, the spherical aberration can be canceled. Image quality deterioration can be suppressed.

Note that, instead of the above-described configuration, the optical system 121 may be configured to first guide the vertically polarized light reflected by the polarization beam splitter 42 to the image sensor 122. In this case, the vertically polarized light from the polarization beam splitter 42 passes through the quarter-wave plate 43 and the additional objective lens 5, is further reflected by the mirror 6, passes through the additional objective lens 5 and the quarter-wave plate 43, and finally becomes the horizontally polarized light. The polarization beam splitter 42 transmits the horizontally polarized light from the quarter-wave plate 43 toward the image sensor 122 (toward the imaging lens 7).

### Second Modification Example

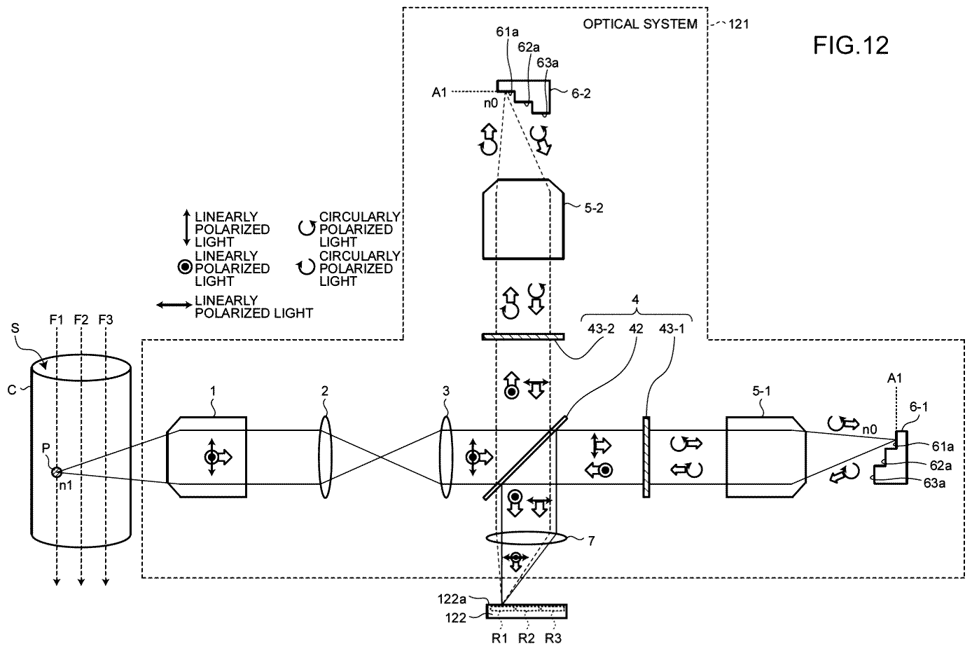

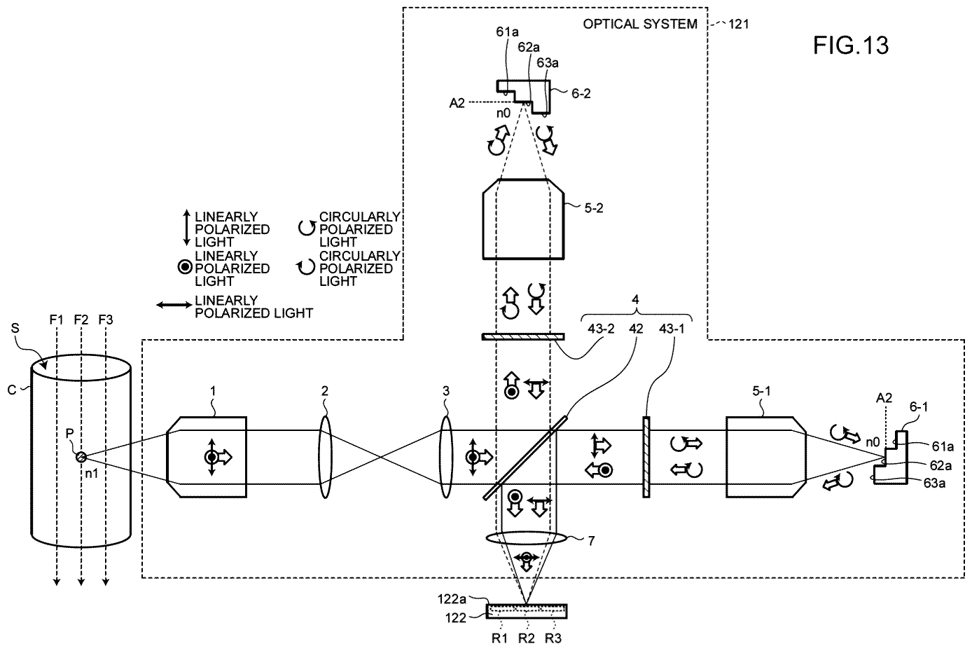

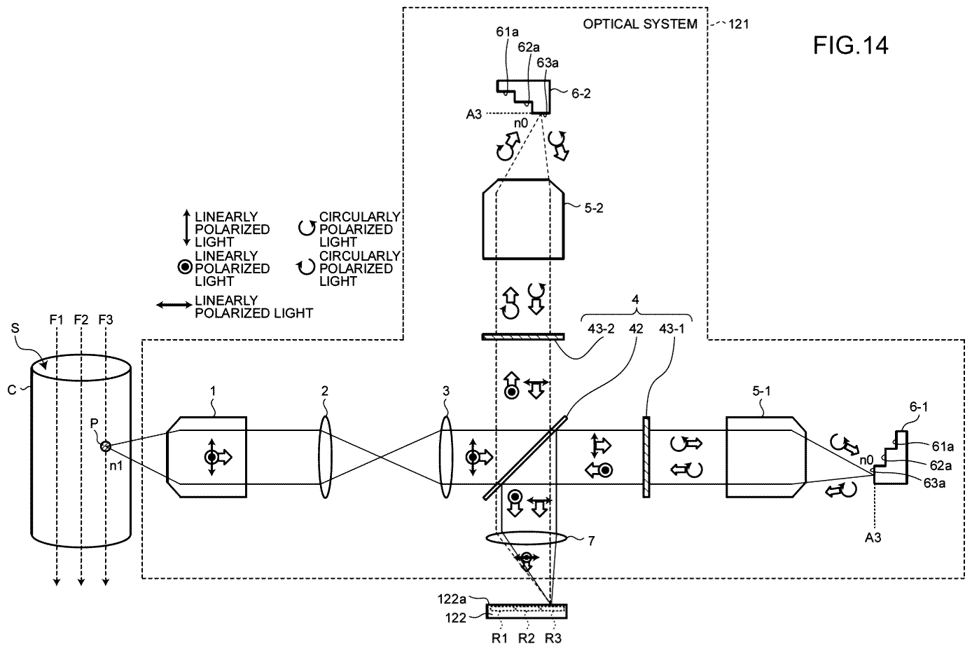

FIGS. 12 to 14 are diagrams illustrating a second modification example. FIG. 12 illustrates the particle P passing through the path F1. FIG. 13 illustrates the particle P passing through the path F2. FIG. 14 illustrates the particle P passing through the path F3.

In this example, the optical system 121 includes two additional objective lenses 5 and two mirrors 6 compared to the configuration of FIGS. 9 to 11 described above. In addition, the intermediate optical element 4 includes two quarter-wave plates 43.

Of the two additional objective lenses 5, a first additional objective lens 5 is referred to as an additional objective lens 5-1 in the drawing. A second additional objective lens 5 is referred to as an additional objective lens 5-2 in the drawing. Of the two mirrors 6, a first mirror 6 is referred to as a mirror 6-1 in the drawing. A second mirror 6 is referred to as a mirror 6-2 in the drawing. The mirror 6-1 reflects the light from the additional objective lens 5-1 toward the additional objective lens 5-1. The mirror 6-2 reflects the light from the additional objective lens 5-2 toward the additional objective lens 5-2. Of the two quarter-wave plates 43, a first quarter-wave plate 43 is referred to as a quarter-wave plate 43-1 in the drawing. A second quarter-wave plate 43 is referred to as a quarter-wave plate 43-2 in the drawing.

The polarization beam splitter 42 of the intermediate optical element 4 transmits the horizontally polarized light included in the light from the objective lens 1 (toward the quarter-wave plate 43-1) and reflects the vertically polarized light (toward the quarter-wave plate 43-2).

The quarter-wave plate 43-1 converts the horizontally polarized light from the polarization beam splitter 42 into corresponding circularly polarized light, that is, right-handed circularly polarized light in this example. The right-handed circularly polarized light is focused on the reflective surface 6a of the mirror 6-1 by the additional objective lens 5-1 and is reflected by the reflective surface 6a. By this reflection, the right-handed circularly polarized light becomes the left-handed circularly polarized light, passes through the additional objective lens 5-1, and enters the quarter-wave plate 43-1. The quarter-wave plate 43-1 converts the left-handed circularly polarized light that has been reflected by the mirror 6-1 and has passed through the additional objective lens 5-1 into corresponding linearly polarized light, that is, the vertically polarized light in this example.

The quarter-wave plate 43-2 converts the vertically polarized light from the polarization beam splitter 42 into corresponding circularly polarized light, that is, left-handed circularly polarized light in this example. The left-handed circularly polarized light is focused on the reflective surface 6a of the mirror 6-2 by the additional objective lens 5-2 and is reflected by the reflective surface 6a. By this reflection, the left-handed circularly polarized light becomes the right-handed circularly polarized light, passes through the additional objective lens 5-2, and enters the quarter-wave plate 43-2. The quarter-wave plate 43-2 converts the right-handed circularly polarized light that has been reflected by the mirror 6-2 and has passed through the additional objective lens 5-2 into corresponding linearly polarized light, that is, the horizontally polarized light in this example.

The polarization beam splitter 42 reflects the vertically polarized light from the quarter-wave plate 43-1 toward the image sensor 122 (toward the imaging lens 7), and transmits the horizontally polarized light from the quarter-wave plate 43-2 toward the image sensor 122 (toward the imaging lens 7). This light is focused by the imaging lens 7 and is imaged by the image sensor 122.

According to the above configuration, both the vertically polarized light and the horizontally polarized light included in the light from the particle P, that is, all of the light from the particle P can be guided to the image sensor 122. The loss of light amount that may occur when only one of the polarized lights is guided to the image sensor 122 is eliminated, and therefore, a greater amount of light can be incident on the image sensor 122. For example, light detection sensitivity in the image sensor 122 can be improved.

### 3. Specific Examples of Design

An example of specific design of the optical system 121 will be described. Here, it is assumed that the optical system 121 has the configurations of FIGS. 12 to 14 described above. Note that in a case where the mirror 6-1 and the mirror 6-2 are not particularly distinguished, they are simply referred to as the mirror 6.

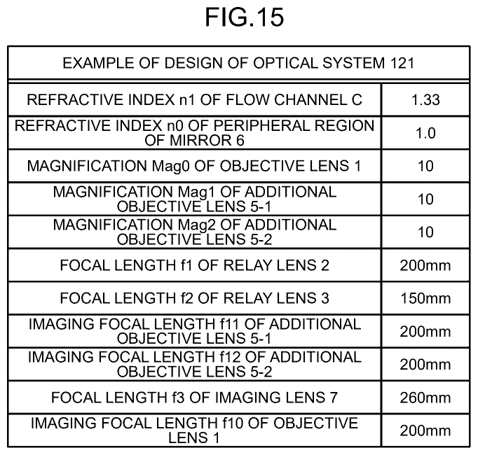

FIG. 15 is a diagram illustrating an example of design of the optical system. The flow channel C is filled with water, and the refractive index n1 thereof is 1.33. The peripheral region of the mirror 6 is an air region, and the refractive index no thereof is 1.0. The image forming magnification (=n1/n0) on the mirror 6 for canceling the spherical aberration is 1.33.

The magnification of the objective lens 1 is set to Mag0, the magnification of the additional objective lens 5-1 is set to Mag1, the magnification of the additional objective lens 5-2 is set to Mag2, the focal length of the relay lens 2 is set to f1, and the focal length of the relay lens 3 is set to f2. The image forming magnification on the mirror 6-1 is expressed by the following Expression (1). The image forming magnification on the mirror 6-2 is expressed by the following Expression (2).

$$Image forming magnification on mirror 6 - 1 = Mag 0 \times \frac{( \frac{f 1}{f 2} )}{Mag 1} \qquad ( 1 )$$

$$Image forming magnification on mirror 6 - 2 = Mag 0 \times \frac{( \frac{f 1}{f 2} )}{Mag 2} \qquad ( 2 )$$

The magnification Mag0 of the objective lens 1, the focal length f1 of the relay lens 2, the focal length f3 of the relay lens 3, the magnification Mag1 of the additional objective lens 5-1, and the Mag2 of the additional objective lens 5-2 are designed so that the respective image forming magnifications of the above Expressions (1) and (2) are 1.33.

In the example illustrated in FIG. 15, the magnification Mag0 of the objective lens 1, the magnification Mag1 of the additional objective lens 5-1, and the magnification Mag2 of the additional objective lens 5-2 are all 10. A focal length f1 of the relay lens 2 is 200 mm. The focal length of the relay lens 3 is 150 mm. As a result, both the image forming magnification on the mirror 6-1 and the image forming magnification on the mirror 6-2 become 1.33, and the spherical aberration is canceled. Note that in FIG. 15, the imaging focal length of the objective lens 1 is illustrated as an imaging focal length f10=200 mm.

Note that the image forming magnification can also be adjusted by the focal length f1 of the relay lens 2 and the focal length f2 of the relay lens 3. That is, by using the relay lens 2 and the relay lens 3, it is easy to design the optical system 121 including adjustment of the image forming magnification.

For example, in a case where the pixel resolution required for the image of the particle P is 0.5 μm and the pixel size of the image sensor 122 is 5 μm, the image forming magnification required for the image sensor 122 is 10 times. Here, the imaging focal length of the additional objective lens 5-1 is defined as an imaging focal length f11. The imaging focal length of the additional objective lens 5-2 is defined as an imaging focal length f12. The focal length of the imaging lens 7 is defined as a focal length f3. The image forming magnification of the light (reflected image) from the mirror 6-1 on the image sensor 122 is expressed by the following Equation (3). The image forming magnification of the light from the mirror 6-2 on the image sensor 122 is expressed by the following Equation (4).

$$Image forming magnification of light from mirror 6 - 1 on image sensor 122 = ( \frac{n 1}{n 0} ) \times Mag 1 \times ( \frac{f 11}{f 3} ) \qquad ( 3 )$$

$$Image forming magnification of light from mirror 6 - 2 on image sensor 122 = ( \frac{n 1}{n 0} ) \times Mag 2 \times ( \frac{f 12}{f 3} ) \qquad ( 4 )$$

The imaging focal length f11 of the additional objective lens 5-1, the imaging focal length f12 of the additional objective lens 5-2, and the focal length f3 of the imaging lens 7 are designed such that the image forming magnification of each of the above Expressions (3) and (4) becomes 10.

In the example illustrated in FIG. 15, both the imaging focal length f11 of the additional objective lens 5-1 and the imaging focal length f12 of the additional objective lens 5-2 are 200 mm. The focal length f3 of the imaging lens 7 is 260 mm.

For example, the spherical aberration can be canceled by designing the optical system 121 as described above. It is also possible to obtain an image with a desired resolution.

### 4. Examples of Hardware Configuration

FIG. 16 is a diagram illustrating an example of a hardware configuration. A part of the analysis system 100, for example, the signal processing unit 124, the information processing unit 130, and the like can be realized by a computer 1000 illustrated in FIG. 16. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records the program for realizing each operation according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. In addition, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, the CPU 1100 of the computer 1000 realizes the functions of the signal processing unit 124 and the information processing unit 130 by executing the program loaded on the RAM 1200. In addition, the HDD 1400 stores the program or the like according to the present disclosure. Note that the CPU 1100 executes the program data 1450 by reading the program data 1450 from the HDD 1400, but as another example, may acquire these programs from another device via the external network 1550.

### 5. Example of Effects

The technique described above is specified as follows, for example. One of the disclosed techniques is the analysis system 100. As described with reference to FIGS. 1 and 3 to 14 and the like, the analysis system 100 includes the optical system 121 that guides light from the particles P flowing in the flow channel C to the image sensor 122. The optical system 121 includes the objective lens 1 facing the flow channel C, the additional objective lens 5 that forms an image of light passing through the objective lens 1, and the mirror 6 that reflects light from the additional objective lens 5 toward the additional objective lens 5. The light from the particle P passing through the different position in the flow channel C (for example, on any path of the path F1 to the path F3) passes through the objective lens and the additional objective lens 5, and then is focused at the different image forming position (for example, any image forming position of the image forming position A1 to the image forming position A3). The mirror 6 has a plurality of reflective surfaces (for example, the reflective surface 61a to the reflective surface 63a) positioned at different image forming positions. The objective lens 1 is provided with the spherical aberration correction with respect to the focal plane, and the additional objective lens 5 is provided with the spherical aberration correction with respect to the focal plane similarly to the objective lens 1.

With the analysis system 100 described above, even in a case where the particle P passes through any position in the flow channel C, the light from the particle P is focused by the mirror 6 having the reflective surface positioned at the image forming position, and the reflected light is imaged by the image sensor 122. As a result, even in a case where the particle P passes through any position in the flow channel C, an image of the particle P focused on the particle P can be obtained. In addition, by providing the additional objective lens 5, it is possible to cancel the spherical aberration that may occur when light from the particle P passes through the objective lens 1. As a result, it is possible to obtain image quality having a good focus state and no (or suppressed) spherical aberration. Therefore, deterioration of image quality can be suppressed.

As described with reference to FIGS. 3 to 6 and the like, the mirror 6 may have a staircase shape. For example, the mirror 6 has such a shape, so that it is possible to obtain a plurality of reflective surfaces (for example, the reflective surface 61a to the reflective surface 63a) positioned at different image forming positions.

As described with reference to FIGS. 3 to 5, 15 and the like, the optical system 121 may be designed such that the image forming magnification of light from the particle P on the mirror 6 matches a ratio (n1/n0) of a refractive index n1 in the flow channel C to a refractive index no of a peripheral region of the mirror 6. For example, the spherical aberration can be canceled in this way.

As described with reference to FIGS. 3 to 5, 9 to 14, and the like, the optical system 121 may include the imaging lens 7 that forms an image of light, which has been reflected by the mirror 6 and has passed through the additional objective lens 5, on the image sensor 122, and the imaging lens 7 has a magnification larger than an image forming magnification of light from the particle on the mirror 6. As a result, for example, the possibility of obtaining a high-resolution image is increased.

As described with reference to FIGS. 3 to 5, 9 to 14, and the like, the optical system 121 may include the intermediate optical element 4 disposed between the objective lens 1 and the additional objective lens 5, and the intermediate optical element 4 may guide at least a part of light from the objective lens 1 to the additional objective lens 5, and guide at least a part of light that has been reflected by the mirror 6 and has passed through the additional objective lens 5 to the image sensor 122. For example, by providing such an intermediate optical element 4, light from the particle P can be guided to the image sensor 122.

As described with reference to FIGS. 3 to 5 and the like, the intermediate optical element 4 may include the half mirror 41. By using the intermediate optical element 4 having such a simple configuration, for example, the possibility that the configuration of the optical system 121 can be simplified is increased.

As described with reference to FIGS. 9 to 11 and the like, the intermediate optical element 4 may include the polarization beam splitter 42 that transmits one type of linearly polarized light of two types of linearly polarized light included in light from the objective lens 1, and reflects the other type of linearly polarized light, and the quarter-wave plate 43 that converts linearly polarized light from the polarization beam splitter 42 into corresponding circularly polarized light, and converts circularly polarized light that has been reflected by the mirror 6 and has passed through the additional objective lens 5 into corresponding linearly polarized light, and the polarization beam splitter 42 may transmit or reflect linearly polarized light from the quarter-wave plate 43 toward the image sensor 122. Alternatively, the polarization beam splitter 42 may transmit the linearly polarized light from the quarter-wave plate 43 toward the image sensor 122. For example, by the intermediate optical element 4 having such a configuration, at least a part of the light from the objective lens 1 can be guided to the additional objective lens 5, and at least a part of the light that has been reflected by the mirror 6 and has passed through the additional objective lens 5 can be guided to the image sensor 122.

As described with reference to FIGS. 12 to 14 and the like, the optical system 121 may include the additional objective lens 5-1 (first additional objective lens), the additional objective lens 5-2 (second additional objective lens), the mirror 6-1 (first mirror) that reflects light from the additional objective lens 5-1 toward the additional objective lens 5-1, and the mirror 6-2 (second mirror) that reflects light from the additional objective lens 5-2 toward the additional objective lens 5-2, the intermediate optical element 4 may include the polarization beam splitter 42 that transmits one type of linearly polarized light of two types of linearly polarized light included in light from the objective lens 1 and reflects the other type of linearly polarized light, the quarter-wave plate 43-1 (first quarter-wave plate) that converts one type of linearly polarized light from the polarization beam splitter 42 into corresponding circularly polarized light and converts circularly polarized light that has been reflected by the mirror 6-1 and has passed through the additional objective lens 5-1 into corresponding linearly polarized light, and the quarter-wave plate 43-2 (second quarter-wave plate) that converts the other type of linearly polarized light from the polarization beam splitter 42 into corresponding circularly polarized light and converts circularly polarized light that has been reflected by the mirror 6-2 and has passed through the additional objective lens 5-2 into corresponding linearly polarized light, and the polarization beam splitter 42 may reflect linearly polarized light from the quarter-wave plate 43-1 toward the image sensor 122 and transmit linearly polarized light from the quarter-wave plate 43-2 toward the image sensor 122. Thus, all the light from the particles P can be guided to the image sensor 122. By allowing a greater amount of light to be incident on the image sensor 122, for example, the light detection sensitivity in the image sensor 122 can be improved.

As described with reference to FIG. 8 and the like, the image sensor 122 may include a TDI type image sensor. For example, even in a case where the speed of the particles P flowing through the flow channel C is faster than the exposure time required to acquire a still image, a still image with sufficient brightness and no blurring can be obtained.

As described with reference to FIG. 8 and the like, the image sensor 122 may include an EVS. For example, the possibility of obtaining high detection sensitivity, high-speed operation, and the like is increased as compared with the case of using a normal image sensor. In addition, since a TDI image can be obtained by software processing, advantages similar to those of the TDI type image sensor can be obtained.

As described with reference to FIGS. 1 and 8 and the like, the image sensor 122 may include a frame type image sensor, and the analysis system 100 may include a light irradiation unit 110 that performs pulse illumination in the flow channel C in conjunction with a passage position of the particle P in the flow channel C. There is no need to individually perform TDI processing of images having different focal planes, and imaging can be performed in a single frame.

As described with reference to FIGS. 3 to 5, 9 to 15, and the like, the optical system 121 may include a relay lens (for example, the relay lens 2, the relay lens 3) provided between the objective lens 1 and the additional objective lens 5. Since the image forming magnification can be adjusted by the focal length of the relay lens (for example, the focal length f1 of the relay lens 2, the focal length f2 of the relay lens 3), the optical system 121 can be easily designed.

As described with reference to FIG. 1 and the like, the particle P may be a biological particle. As a result, the analysis system 100 can be used as the biological sample analysis system or biological particle analysis system.

An analysis method using the analysis system 100 is also one of the disclosed techniques. The analysis method includes guiding light from the particle P flowing in the flow channel C to the optical system 121 by using the optical system 121. Also by such an analysis method, it is possible to suppress deterioration in image quality as described above.

The embodiment of the present disclosure has been described above. Light reflection can be suppressed by various techniques described so far. Note that the effects described in the present disclosure are merely examples and are not limited to the disclosed contents. There may be other effects.

The technical scope of the present disclosure is not limited to the above-described embodiment as it is, and various modifications can be made without departing from the gist of the present disclosure. In addition, components of different embodiments and modification examples may be appropriately combined.

Note that the disclosed techniques can also have the following configurations.

(1) An analysis system comprising:
an optical system that guides light from a particle flowing in a flow channel to an image sensor, wherein
the optical system includes
an objective lens facing the flow channel,
an additional objective lens that forms an image of light passing through the objective lens, and
a mirror that reflects light from the additional objective lens toward the additional objective lens,
light from the particle passing through a different position in the flow channel passes through the objective lens and the additional objective lens, and then is focused at a different image forming position, and
the mirror has a plurality of reflective surfaces respectively positioned at different image forming positions.

(2) The analysis system according to (1), wherein
the objective lens is provided with spherical aberration correction with respect to a focal plane, and
the additional objective lens is provided with spherical aberration correction with respect to a focal plane similarly to the objective lens.

(3) The analysis system according to (1) or (2), wherein
the mirror has a staircase shape.

(4) The analysis system according to any one of (1) to (3), wherein
the optical system is designed such that an image forming magnification of light from the particle on the mirror matches a ratio of a refractive index in the flow channel to a refractive index of a peripheral region of the mirror.

(5) The analysis system according to any one of (1) to (4), wherein
the optical system includes an imaging lens that forms an image of light, which has been reflected by the mirror and has passed through the additional objective lens, on the image sensor, and
the imaging lens has a magnification larger than an image forming magnification of light from the particle on the mirror.

(6) The analysis system according to any one of (1) to (5), wherein
the optical system includes an intermediate optical element disposed between the objective lens and the additional objective lens, and
the intermediate optical element guides at least a part of light from the objective lens to the additional objective lens, and guides at least a part of light that has been reflected by the mirror and has passed through the additional objective lens to the image sensor.

(7) The analysis system according to (6), wherein
the intermediate optical element includes a half mirror.

(8) The analysis system according to (6), wherein
the intermediate optical element includes
a polarization beam splitter that transmits one type of linearly polarized light of two types of linearly polarized light included in light from the objective lens, and reflects the other type of linearly polarized light, and
a quarter-wave plate that converts linearly polarized light from the polarization beam splitter into corresponding circularly polarized light, and converts circularly polarized light that has been reflected by the mirror and has passed through the additional objective lens into corresponding linearly polarized light, and
the polarization beam splitter transmits or reflects linearly polarized light from the quarter-wave plate toward the image sensor.

(9) The analysis system according to (6), wherein
the optical system includes
a first additional objective lens,
a second additional objective lens,
a first mirror that reflects light from the first additional objective lens toward the first additional objective lens, and
a second mirror that reflects light from the second additional objective lens toward the second additional objective lens,
the intermediate optical element includes
a polarization beam splitter that transmits one type of linearly polarized light of two types of linearly polarized light included in light from the objective lens and reflects the other type of linearly polarized light,
a first quarter-wave plate that converts one type of linearly polarized light from the polarization beam splitter into corresponding circularly polarized light and converts circularly polarized light that has been reflected by the first mirror and has passed through the first additional objective lens into corresponding linearly polarized light, and
a second quarter-wave plate that converts the other type of linearly polarized light from the polarization beam splitter into corresponding circularly polarized light and converts circularly polarized light that has been reflected by the second mirror and has passed through the second additional objective lens into corresponding linearly polarized light, and
the polarization beam splitter reflects linearly polarized light from the first quarter-wave plate toward the image sensor and transmits linearly polarized light from the second quarter-wave plate toward the image sensor.

(10) The analysis system according to any one of (1) to (9), wherein
the image sensor includes a time delay integration (TDI) type image sensor.

(11) The analysis system according to any one of (1) to (10), wherein
the image sensor includes an event-based vision sensor (EVS).

(12) The analysis system according to any one of (1) to (11), wherein
the image sensor includes a frame type image sensor, and
the analysis system includes a light irradiation unit that performs pulse illumination in the flow channel in conjunction with a passage position of the particle in the flow channel.

(13) The analysis system according to any one of (1) to (12), wherein
the optical system includes a relay lens provided between the objective lens and the additional objective lens.

(14) The analysis system according to any one of (1) to (13), wherein
the particle is a biological particle.

(15) An analysis method comprising:
guiding light from a particle flowing in a flow channel to an image sensor by using an optical system, wherein
the optical system includes
an objective lens facing the flow channel,
an additional objective lens that forms an image of light passing through the objective lens, and
a mirror that reflects light from the additional objective lens toward the additional objective lens,
light from the particle passing through a different position in the flow channel passes through the objective lens and the additional objective lens, and then is focused at a different image forming position, and
the mirror has a plurality of reflective surfaces respectively positioned at different image forming positions.

### REFERENCE SIGNS LIST

1 OBJECTIVE LENS
2 RELAY LENS
3 RELAY LENS
4 INTERMEDIATE OPTICAL ELEMENT
41 HALF MIRROR
42 POLARIZATION BEAM SPLITTER
43 QUARTER-WAVE PLATE
43-1 QUARTER-WAVE PLATE
43-2 QUARTER-WAVE PLATE
5 ADDITIONAL OBJECTIVE LENS
5-1 ADDITIONAL OBJECTIVE LENS
5-2 ADDITIONAL OBJECTIVE LENS
6 MIRROR
6a REFLECTIVE SURFACE
6-1 MIRROR
6-2 MIRROR
61 FIRST PORTION
62 SECOND PORTION
63 THIRD PORTION
61a REFLECTIVE SURFACE
62a REFLECTIVE SURFACE
63a REFLECTIVE SURFACE
7 IMAGING LENS
100 ANALYSIS SYSTEM
110 LIGHT IRRADIATION UNIT
111 LIGHT SOURCE UNIT
112 OPTICAL SYSTEM
120 DETECTION UNIT
121 OPTICAL SYSTEM
122 IMAGE SENSOR
122a LIGHT RECEIVING SURFACE
123 SPEED MEASUREMENT UNIT
124 SIGNAL PROCESSING UNIT
130 INFORMATION PROCESSING UNIT
140 SORTING UNIT
150 WELL PLATE
160 PARTICLE NUMBER MEASUREMENT UNIT
A1 IMAGE FORMING POSITION
A2 IMAGE FORMING POSITION
A3 IMAGE FORMING POSITION
C FLOW CHANNEL
F1 PATH
P PARTICLE
R1 REGION
R2 REGION
R3 REGION
S SAMPLE
n0 REFRACTIVE INDEX
n1 REFRACTIVE INDEX

1. An analysis system comprising:
an optical system that guides light from a particle flowing in a flow channel to an image sensor, wherein
the optical system includes
an objective lens facing the flow channel,
an additional objective lens that forms an image of light passing through the objective lens, and
a mirror that reflects light from the additional objective lens toward the additional objective lens,
light from the particle passing through a different position in the flow channel passes through the objective lens and the additional objective lens, and then is focused at a different image forming position, and
the mirror has a plurality of reflective surfaces respectively positioned at different image forming positions.

2. The analysis system according to claim 1, wherein
the objective lens is provided with spherical aberration correction with respect to a focal plane, and
the additional objective lens is provided with spherical aberration correction with respect to a focal plane similarly to the objective lens.

3. The analysis system according to claim 1, wherein
the mirror has a staircase shape.

4. The analysis system according to claim 1, wherein
the optical system is designed such that an image forming magnification of light from the particle on the mirror matches a ratio of a refractive index in the flow channel to a refractive index of a peripheral region of the mirror.

5. The analysis system according to claim 1, wherein
the optical system includes an imaging lens that forms an image of light, which has been reflected by the mirror and has passed through the additional objective lens, on the image sensor, and
the imaging lens has a magnification larger than an image forming magnification of light from the particle on the mirror.

6. The analysis system according to claim 1, wherein
the optical system includes an intermediate optical element disposed between the objective lens and the additional objective lens, and
the intermediate optical element guides at least a part of light from the objective lens to the additional objective lens, and guides at least a part of light that has been reflected by the mirror and has passed through the additional objective lens to the image sensor.

7. The analysis system according to claim 6, wherein
the intermediate optical element includes a half mirror.

8. The analysis system according to claim 6, wherein
the intermediate optical element includes
a polarization beam splitter that transmits one type of linearly polarized light of two types of linearly polarized light included in light from the objective lens, and reflects the other type of linearly polarized light, and
a quarter-wave plate that converts linearly polarized light from the polarization beam splitter into corresponding circularly polarized light, and converts circularly polarized light that has been reflected by the mirror and has passed through the additional objective lens into corresponding linearly polarized light, and
the polarization beam splitter transmits or reflects linearly polarized light from the quarter-wave plate toward the image sensor.

9. The analysis system according to claim 6, wherein
the optical system includes
a first additional objective lens,
a second additional objective lens,
a first mirror that reflects light from the first additional objective lens toward the first additional objective lens, and
a second mirror that reflects light from the second additional objective lens toward the second additional objective lens,
the intermediate optical element includes
a polarization beam splitter that transmits one type of linearly polarized light of two types of linearly polarized light included in light from the objective lens and reflects the other type of linearly polarized light,
a first quarter-wave plate that converts one type of linearly polarized light from the polarization beam splitter into corresponding circularly polarized light and converts circularly polarized light that has been reflected by the first mirror and has passed through the first additional objective lens into corresponding linearly polarized light, and
a second quarter-wave plate that converts the other type of linearly polarized light from the polarization beam splitter into corresponding circularly polarized light and converts circularly polarized light that has been reflected by the second mirror and has passed through the second additional objective lens into corresponding linearly polarized light, and
the polarization beam splitter reflects linearly polarized light from the first quarter-wave plate toward the image sensor and transmits linearly polarized light from the second quarter-wave plate toward the image sensor.

10. The analysis system according to claim 1, wherein
the image sensor includes a time delay integration (TDI) type image sensor.

11. The analysis system according to claim 1, wherein
the image sensor includes an event-based vision sensor (EVS).

12. The analysis system according to claim 1, wherein
the image sensor includes a frame type image sensor, and
the analysis system includes a light irradiation unit that performs pulse illumination in the flow channel in conjunction with a passage position of the particle in the flow channel.

13. The analysis system according to claim 1, wherein
the optical system includes a relay lens provided between the objective lens and the additional objective lens.

14. The analysis system according to claim 1, wherein
the particle is a biological particle.

15. An analysis method comprising:
guiding light from a particle flowing in a flow channel to an image sensor by using an optical system, wherein
the optical system includes
an objective lens facing the flow channel,
an additional objective lens that forms an image of light passing through the objective lens, and
a mirror that reflects light from the additional objective lens toward the additional objective lens,
light from the particle passing through a different position in the flow channel passes through the objective lens and the additional objective lens, and then is focused at a different image forming position, and
the mirror has a plurality of reflective surfaces respectively positioned at different image forming positions.
